(19) United States
(12) Patent Application Publication
(10) Pub. No.: US 2010/0269143 A1
(43) Pub. Date: Oct. 21, 2010

(54) System and Method for Satellite Enhanced Command, Control, and Surveillance Services Between Network Management Centers and Unmanned Land and Aerial Devices

(76) Inventor: Irving Rabowsky, Oxnard, CA (US)

Correspondence Address: Irving Rabowsky, 328 Sunset Drive, Oxnard, CA, 93035-4478, US

(21) Appl. No.: 12/427,175

(22) Filed: Apr. 21, 2009

(51) Int. Cl. H04N 7/20; H04B 7/185

(52) U.S. Cl. 725/63; 370/316

(57) ABSTRACT

A novel system and method for electronic delivery of command, control information to many land and aerial devices, simultaneously or individually, and transmission of video, audio, location, and other information from devices to user defined entities such as network management centers, and devices over defined geographic areas utilizing inter-connected communications satellites. Satellites receive data packets which may include command, control, monitoring, video, audio, sensor, graphics, response, and other data, redistributes them to multiple destination addresses within other systems and subsystems and radiates source power to devices. Display centers receive video, audio, and sensor data, stores the data files for playback on command, and creates maps utilizing geographic information software and other displays suitable for electronic displays. Operators are able to view and hear video camera output in real-time, or delayed, and issue commands, in any geographic area where devices are present.

### BACKGROUND OF THE INVENTION

1. Field of the Invention

This invention concerns delivery of command, control, video, audio, maps, response, and other data services to and from many land based and aerial devices over user defined geographic areas utilizing special purpose communications satellites. Specifically, this invention relates to a system, and methods for electronic delivery of command, control information to many mobile vehicles and devices simultaneously or individually, and the transmission of video, audio, location, status, and other information from such vehicles and devices to user defined entities such as Network Management Centers and/or groups of user defined vehicles and devices. Depending on the user requirement, one or more communications satellites can be configured to provide from wide area geographic coverage to local coverage anywhere in the world.

2. Description of the Related Art

The current method of delivery of command, control, and video services is by means of local radio services, including mobile radio transceivers, aircraft transceivers, communications satellite transponders, and WIFI services. Radio transceivers incorporated into unmanned aerial vehicles together with a local ground based local Command and Control base station are also used to provide a coordinated action by groups of such vehicles. This conventional delivery method suffers from several disadvantages. First, the geographic area of coverage is limited by the radio or satellite area of coverage. Second, the command and control actions are defined by the local Command and Control Center, and thus are not readily responsive to concerns and considerations by the User's central management. Third, wide-area coverage or multi-area coverage are difficult to achieve, or may be impossible to achieve with the current systems. Fourth, video and other information transmitted by the vehicles and devices cannot be viewed in real-time at a number of User specified locations simultaneously. Fifth, real-time redefinition of system mission, resources, command and control instructions and functions, and reconfiguration of areas of coverage and data outputs of vehicles and devices cannot be done on a regional or global basis. Sixth, display of surveillance data as an overlay on an associated geographic area map is not available in network management centers. Seventh, response devices are not included in current system architectures, making real-time response unavailable. Patent Applications 20080215204; Roy, Phillipe, dated Sep. 4, 2008; 20070152814; Stefani, Rolf, dated Jul. 5, 2007; and 20070021880; Appleby, Brent D., dated Jan. 5, 2007, exemplify the current state of the art.

What is needed is a technology focused on the of delivery of command, control, and other services to land-based and aerial vehicles and devices, and the delivery of video, audio, monitoring, and other data to command, control, monitoring, and display centers, utilizing user configurable communications satellites with special capabilities to provide point-to-point, point-to multipoint, and satellite-to-satellite communications.

### SUMMARY OF THE INVENTION

The present invention satisfies this need by providing a communications satellite enabled delivery system which includes special purpose satellites, unmanned aerial devices such as drones, ground-based vehicles, and other devices, which have incorporated within them technologies of the present invention. In particular, the system of the present invention comprises a communications satellites system, satellite telemetry, tracking, and control systems, network/video management systems, vehicle-device systems, and response systems. The communications satellites system comprises one or more communications satellites with on-board packet processing, a graphics/video processing supercomputer capable of processing high resolution video data at frame rates consistent with device video cameras, and reconfigurable RF transmission beams, bandwidth allocations, and point-to-point and point-to multipoint channel allocations. Laser and/or microwave links may be provided to provide communications between satellites, thus extending the geographic range of network management centers. Optional laser and/or microwave beams may be provided to provide supplemental power to micro-unmanned aerial vehicles to extend operational life on location. A satellite telemetry, tracking, and control system controls and monitors the performance of an associated satellite and can reposition the satellite upon direction by a network management system. A network/video management system comprises a satellite earth terminal, a network command, control, and monitor subsystem, a data management and analysis subsystem for receiving and processing data and for forwarding video, audio, sensor and other data to the ultimate destinations, a geographic information subsystem with geographic map creation and analysis capabilities, and a display center with operator computer terminals, and with the ability to display one or more geographic maps with rasterized video overlays together with parameter data sequentially on a frame by frame basis in real time. The vehicle-device system comprises a number of unmanned aerial vehicles, land based vehicles and devices, such as drones, micro-aerial robots, and sensors, each having within it a satellite terminal. A satellite terminal comprises video cameras, sensors, transceivers and antennas which provide RF transmission paths to a specific satellite, a GPS receiver, a camera control subsystem and positioning control subsystem. The GPS receiver together with the positioning control subsystem provide the exact location of the vehicle-device, and the camera control subsystem controls the parameters of the video camera and keeps it pointed at the specified geographic area.

A preferred version of the present invention further comprises one or more response systems which may be manned and/or unmanned aerial vehicles such as drones, or land based vehicles such as robots. The response system includes a satellite terminal similar to the satellite terminal of a vehicle-device, and a command and control subsystem under the control of the network/video management system of the present invention. The response system may respond with weapons, sounds, or other appropriate methods. In a preferred version of the present invention the communications satellites are in geosynchronous orbit, however, lower orbiting satellites may be utilized by providing more complex RF transmission links to other systems of the present invention.

### BRIEF DESCRIPTION OF THE DRAWINGS

FIG. 1 is a block diagram of a preferred version of a system for delivery of command, control, and video services to land-based and aerial vehicles and devices utilizing user configurable communications satellites with special capabilities to provide point-to-point, point-to multipoint, and satellite-to-satellite communications embodying the present invention. In a preferred version of the present invention the communications satellites are in geosynchronous orbit

FIG. 2 is a block diagram of a preferred version of a communications satellite payload system embodying the present invention.

FIG. 3 is a block diagram of a preferred version of a satellite terminal system contained within an aerial or land-based device embodying the present invention.

FIG. 4 is a block diagram of a preferred version of a network/video management system, including a command, control, and display center embodying the present invention.

FIG. 5 is a block diagram of a preferred version of a satellite terminal system contained within a response system embodying the present invention.

FIG. 6 is a block diagram of a preferred version of a satellite telemetry, tracking, and control station embodying the present invention.

### DETAILED DESCRIPTION OF THE INVENTION

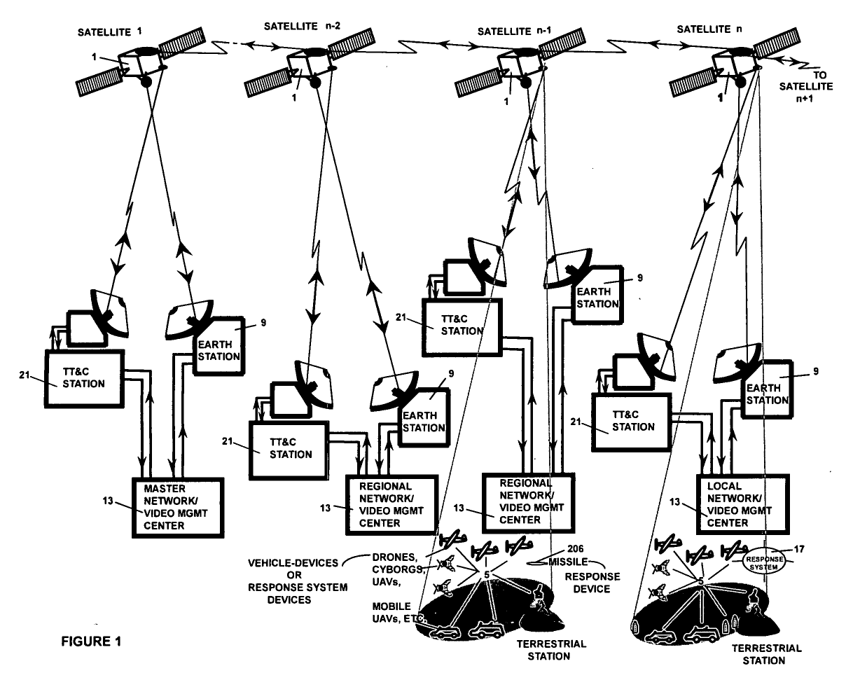

Referring to FIG. 1, the overall system architecture of the present invention comprises five main systems of the Communications Satellites System, the Satellite Payload System which is an internal subsystem of the Communications Satellites(1), the Satellite Terminal System, an internal subsystem of the Vehicle/Device System(5), the Network/Video Management System which consists of a Satellite Earth Station (9) and a Network/Video Management Center (13), Response System, an internal subsystem of a variety of vehicles and/or other equipments (17) and the Satellite Telemetry, Tracking, and Control Station (21).

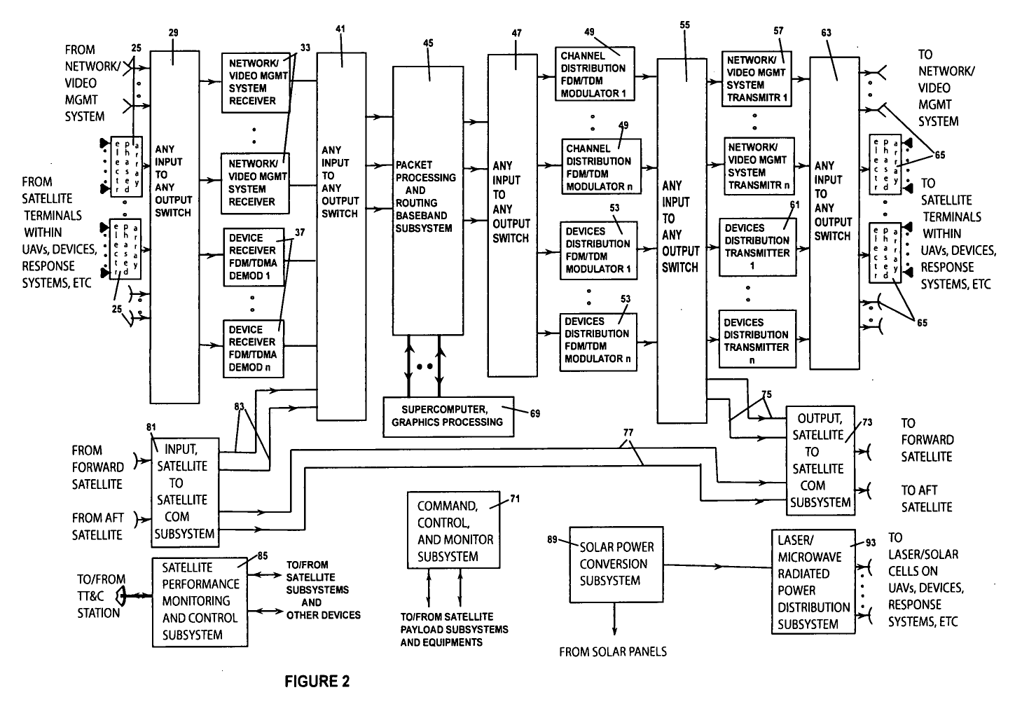

Referring to FIG. 2, the first system is the Satellite Payload System which comprises input antennas (25) which receive RF transmissions from Network/Video Management Systems, and Satellite Terminals within Vehicle-Devices and Response Systems, an Input RF Any Input to Any Output Switch (29), Network/Video Management System (33), and Devices Receivers (37), an Input Baseband Any Input to Any Output Switch (41), a Packet Processing and Routing Baseband Subsystem (45), a Graphics Processing Supercomputer (69), an Output Baseband Any Input to Any Output Switch (47), Channel Distribution (49) and Devices Distribution Modulators (53), an input RF Any Input to Any Output Switch (55), Network/Video Management System RF Transmitters 57), Devices RF Distribution Transmitter (61), an Output RF Any Input to Any Output Switch (63), output RF Antennas (65) which send RF transmissions to Network Video Management Systems and to Satellite Terminals within Vehicle-Devices and Response Systems, Input (81) and Output Satellite to Satellite Communications Subsystems (73), a Satellite Performance Monitoring and Control Subsystem (85), a Solar Power Conversion Subsystem (89), and a Laser/Microwave Radiated Power Distribution Subsystem (93). The Satellite Payload System provides RF data communications links to all the other systems of the Communications Satellites System. Depending on the application, the Communications Satellites System may have one or more communications satellites, each with its own configurable Satellite Payload System, which are also scalable in scope and capabilities. Data may originate from within any of the five systems of this invention including subsystems of the Communications Satellite external to the payload such as attitude and control data, solar panel performance, and other monitor and control data necessary to control and analyze the performance of the satellite. Data may be received in packetized format or reformatted into packets as prescribed by system software specifications. The packet format includes an appropriate identification (ID), and source and destination information. The packets are directed to the input of the appropriate packet processor which uses the ID, source, and destination information to direct each packet, with appropriate timing, to the proper output port of the processor. Depending on the source of the data, and the command and control instruction residing in the Command, Control, and Monitor Subsystem (71) of the Satellite Payload System, the packets may be directed to any of the other Systems, or to an optional on-board supercomputer capable of processing massive amounts of graphic and video data. The supercomputer may then encrypt, compress and packetize the processed data, and then forward the data to the packet processor for further formatting, processing, and delivery to an appropriate output port. For example, data from a Satellite Terminal may be directed to a Local Network/Video Management System, and/or Regional Network/Video Management System, and/or the Master Network/Video Management System. Laser and/or microwave links may be provided to provide high bandwidth communications links between satellites as required by an application. Thus, for example, video surveillance data provided by vehicle-devices such as unmanned aerial vehicles (UAVs) could be directed not only to a local command center, but to a far-away master command center where the video could be analyzed and action commands issued to the appropriate responders in real-time. In addition, the commands could include instructions to relocate the satellite geographically, and also to reconfigure the geographic locations of UAVs and other mobile devices in a coordinated move and reconfiguration. In addition the command functions may include the ability to modify video camera parameters such as resolution, viewing angle, area of coverage, magnification, and other camera features and processing choices. The invention includes an optional solar power conversion subsystem which converts solar power into laser and/or microwave radiated power emission which is distributed to UAV to increase the geographic range and operational life of such devices.

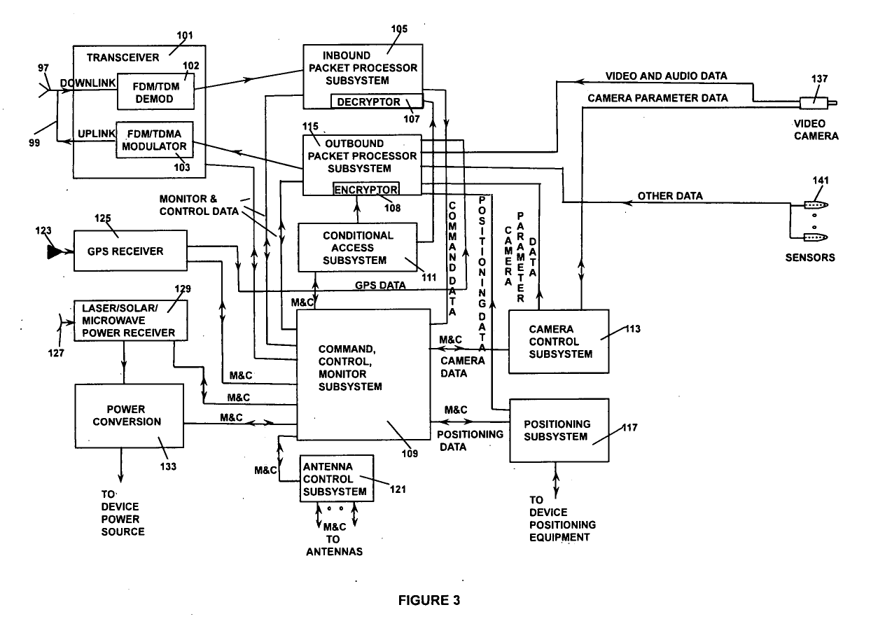

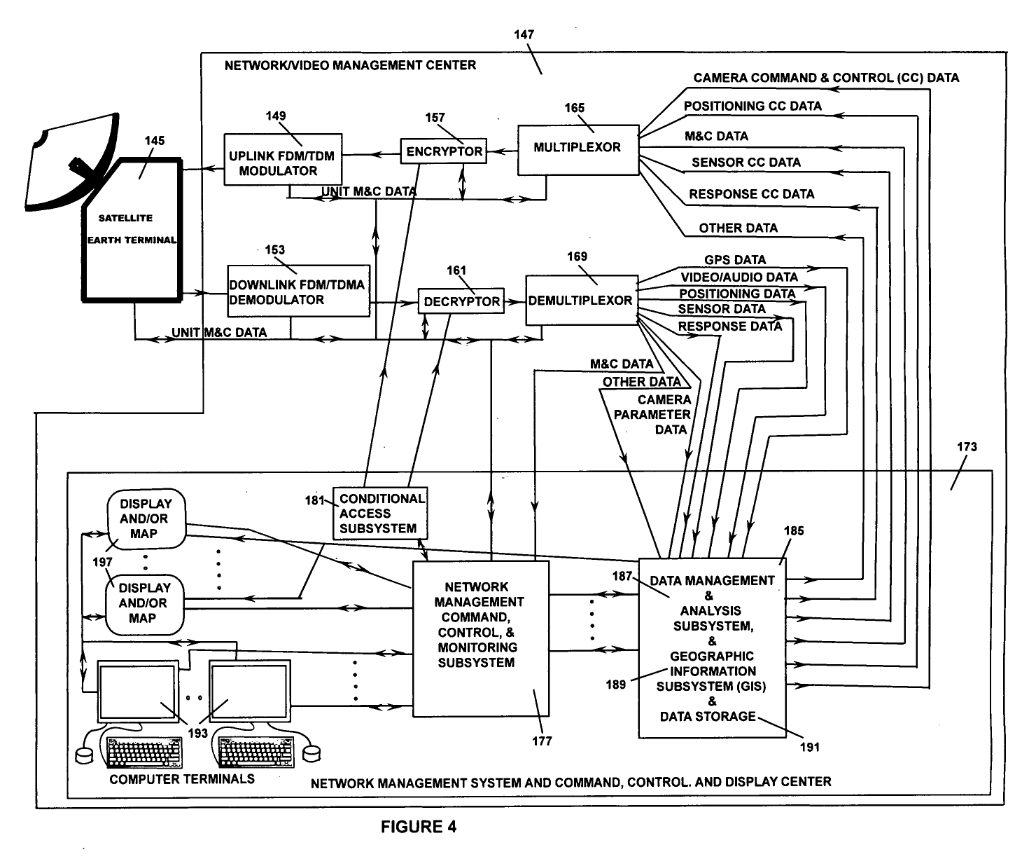

Referring to FIG. 3, the second system is the Satellite Terminal System (Satellite Terminal), which comprises an antenna (97) which may have pointing controls, a radio frequency transceiver (101) which receives signals from a particular satellite, demodulates the signal to baseband, and then forwards the baseband data stream to the Inbound Packet Processor Subsystem (105) which then decrypts (107) the data and forwards it to the Command, Control, and Monitor Subsystem (109) together with data concerning the status and performance of the packet processor. The Command, Control, and Monitor Subsystem (109) then forwards command and control instructions to the Camera Control Subsystem (113), the Positioning Subsystem (117), and the Antenna Control Subsystem (121). The Camera Control Subsystem (113) provides commands to one or more video cameras (137) which adjust all the various parameters of each camera, including frame rate, resolution, compression ratio, aspect ratio, pointing direction, area of coverage and zooming, feature recognition, motion detection, and other camera parameters, depending on the feature set available for the models of the cameras. The Positioning Subsystem (117) of the present invention provides commands to the internal positioning equipment of the Device in which the Satellite Terminal System resides. For example, a drone may have positioning equipment similar to an airplane and require commands to instruct the drone the direction, distance, and altitude to move to. Other UAVs may have a different command structure and methods of propulsion. The Positioning Subsystem (117) keeps a record of the interfacing device systems and subsystems and structures data commands appropriately. The Antenna Control Subsystem (121) provides commands to the antennas (97) of the transceiver (101), the GPS receiver (125), and the Laser/Solar/Microwave Power Receiver (129) so as to reposition the antennas to maintain the RF links to the Satellite. The GPS receiver (123, 125) receives three dimensional data from GPS satellites so that the coordinates of the Satellite Terminal, and thus the Device in which it resides, are known at all times to the Command, Control, and Monitor Subsystem (109), to the Local Satellite, and to the appropriate Network/Video Management Center (147). The Outbound Packet Processor Subsystem (115) receives video, audio, sensor, device GPS location, and other data from the video cameras (137) and sensors (141) of the device. In addition, it receives camera parameter data from the Camera Control Subsystem (113), and Device (a Vehicle-Device or a Response System Device) position data from the Positioning Subsystem (117). In addition, it receives specific monitoring and control data from the Command, Control, and Monitor Subsystem (109), as defined by an authorized Network/Video Management Command, Control, and Display Center (FIG. 4, 173). The data received by the Outbound Packet Processor Subsystem (115) is packetized, encrypted (108) as instructed by the Conditional Access Subsystem (111), and then forwarded to the FDM/TDMA Modulator (103) of the Transceiver (101), which provides a timed burst of one or more packets at an appropriate radio frequency required by the receivers in an associated Local Communications Satellite. The transmitter section of the Transceiver (101) may include a power amplifier and controls to adjust the transmitter power depending on atmospheric or other conditions. The transceiver is connected to the Uplink port (99) of the antenna which provides two way communications with an associated Local Communications Satellite. Another feature of a preferred version of the present invention is the Power Conversion Subsystem (133). Power is received from the Local Satellite by an antenna (127) and/or semiconductor cells located on the outer surface of the Device by utilizing a microwave and/or laser beam of energy. The received energy is then converted into the appropriate format to increase the power stored within the Device, and thus increase the operational life of the Device.

Referring to FIG. 4, the fourth system is the Network/Video Management System, which comprises a Satellite Earth Terminal (145), and a Network/Video Management Center (147) which comprises an Uplink Modulators (149) and Downlink Demodulators (153), Encryptors (157) and Decryptors (161), Multiplexors (165) and Demultiplexors (169), and a Network Management System, and Command, Control, and Display Center (173). In a preferred version of the present invention, the Network/Video Management System (NVMS) is ground based, and may be within the field of view of the same Communications Satellite as the Satellite Terminals in the operational geographic area, or the NVMS may communicate with a different Communications Satellite which is linked through one or more other Communications Satellites which comply with the specifications of the present invention. In an alternate version of the present invention, the NVMS could be airborne, allowing quick deployment and repositioning of the UAVs and other devices to other geographic areas, while maintaining communications with an associated Communications Satellite by utilizing an antenna stabilization system. A preferred version of the present invention uses satellite transmission for communications to and from a NVMS to and from Satellite Terminals in the various devices, such as unmanned aerial vehicles (UAV), sensors, and ground-based vehicles and equipments, via the Communications Satellites System. Uplink signal power level is electronically controlled to provide automatic modification of uplink power during uplink rain fades. The objective is to keep the uplink signal strength constant at the input to the satellite transponder receiver. If the uplink signal uses an entire transponder, a transponder with automatic level control is preferred. The electronics modules of the uplink system preferably have at least 1:1 redundancy and automatically switchover should a failure occur, as directed by the Network Management, Command, Control, and Monitoring Subsystem (177). The Satellite Earth Terminal receives the downlink RF transmission from the associated Communications Satellite and forwards the signal to the Downlink FDM/TDMA Demodulator (153). The specifications of the demodulator depend upon the specifications of the associated Communications Satellites in the Satellite Earth Terminal's field of view. The RF frequency of the Demodulator is provided to it by the Network Management, Command, Control, and Monitoring Subsystem (177) of the Network/Video Management System. In a preferred version of this invention, the baseband output of the demodulator is delivered to a Decryptor (161) which receives instructions from a Conditional Access Subsystem (CAS) (181) enabling the decryption process, and then decrypts the baseband data stream as specified by the CAS. In alternative versions of the present invention, the CAS and encryptors and decryptors may not be required. The output of the Decryptor (161) is delivered to the Demultiplexor (169). The Demultiplexor (169) reads the addresses of the baseband data packets and separates, and reorders them into the individual data streams such as GPS data, video/audio data, positioning data, sensor data response data, monitor and control data, and other data. The individual data streams are then delivered to the Data Management &Analysis Subsystem (187), and Geographic Information Subsystem (189). The Data Management and Analysis Subsystem (DMAS)(187) provides the computer processing capability and data storage facilities required to analyze the packets of each input data stream and create a data stream for each type of data provided by each source of the data, for delayed or immediate usage. For example, in a particular geographic area there may be Vehicle-Devices and Response System Devices (Devices) with Satellite Terminals, numbering from a few to many thousands. Each such Device will have an identification number (ID) which can be used to get a complete description of the Device and the equipment within from a database internal to the DMAS. In addition, the data streams provided to the DMAS from the Demultiplexor is parsed to separate the video and audio data of each Device from every other Device, as well as the Camera Parameter Data, the GPS data, the Positioning data, the Sensor data, the Response System data, the M&C data and Other data. Each Satellite Terminal may include one or more video camera and from none to many Sensors. The video, audio, and camera parameter data are parsed to provide individual data streams for each video camera and the sensor data stream is parsed to provide individual data streams for each sensor. The Camera Parameter data provides the necessary data to completely identify the frame rate, compression technology, compression ratio, resolution, aspect ratio, area of coverage, zoom parameters, frame time stamp, light level, special conditions such as edge detection and motion detection, and any other parameter provided by the Satellite Terminal transmission. The audio data stream, if any, provides fields within the header which define the technology of the audio data stream, for example, AAC or MP3, and the defined parameters of the chosen technology. The GPS data and the Positioning data for each Device provide the DMAS the exact location and the movement of the Device. The location data for each Device is forwarded to the Geographic Information Subsystem (189) which then analyzes the data and constructs a precise, to scale, map or maps of the area of coverage of all the Devices which are under the command and control of the particular NVMS. The Geographic Information Subsystem may provide a map which may show each of the Devices, including Sensors, as a point on the map, or it may provide an operator, with a computer terminal/keyboard and a display, with the ability to click on a device point on the map to expand the map to show the video, and to play a specific audio, of the area of coverage of a specific camera or group of cameras. The Geographic Information Subsystem may also produce a raster map from the video data files of a few cameras to a raster map of all the video data files of the video cameras, in real time, or from video data files, for a specific period of time, which have been previously stored in data storage facilities (191). The Geographic Information Subsystem may also provide such maps based on special conditions such as motion detection data streams or other Command events. The DMAS and Geographic Information Subsystem are under the command and control of the Network Management Command, Control, & Monitoring Subsystem (NMCCMS) (177), which in addition to monitoring the performance of all the subsystems of the NVMS provides the commands to the Geographic Information Subsystem which determine the functioning of the software which creates the maps which are to be displayed in the Command, Control, and Display Center (193, 197). Since the Command, Control, and Display Center may have one to many Displays (197), and one or more Computer Terminals (193) which are automated or operator controlled, the NMCCMS (177) manages the types of maps and their distribution to each Display (197) and the operation and policies of each Computer Terminal (1 93). In a preferred version of the present invention, the system and method for communications satellites enabled command, control, and surveillance services to a multitude of unmanned land based and aerial vehicles, is hierarchical, that is, there may be many Network/Video Management Systems. Each will have a defined role in the overall system architecture depending on the application. Regional NVMSs may have administrative control of the command and control functions of the Local NVMSs, and may exercise direct control over all the functions which may also reside in a Local NVMS, including direct communications with all the Devices in the geographic region of its control duties. In the case when a Regional NVMS exercises direct control over all Devices of a geographic area, the Local NVMS may either not exist, or have limited duties, or act as a backup for the Regional NVMS. A Master NVMS may have administrative control of the command and control functions of the Regional NVMSs, and may exercise direct control over all the functions which may reside in a Regional and/or Local NVMSs, including direct communications with all the Devices in the geographic region of its control duties. In such a situation, a Regional and/or Local NVMS may either not exist, or have limited duties, or act as a backup for the Master NVMS. The Command, Control, and Display Center provides Computer Terminals and Displays with the data streams required to view maps, sensor data, videos with or without audio for one to many Devices in real time, or delayed, or loop back modes, or other methods, and provides analysis and definition of further actions as warranted by the information provided to a terminal operator or automated system in the Computer Terminal. The Computer Terminal may be used to view special Device data, commands, alert messages, and override previous commands. The Computer Terminal Operator (Operator) may issue commands within the permissions of an administrative policy. The Computer Terminal Operator may select which map, video, or audio to display on a specific display and speaker. The Operator may issue specific commands to a specific video camera, or issue repositioning instructions to a specific Satellite Terminal or group of Satellite Terminal. The Operator may issue commands to a specific Response System or group of Response Systems. The Operator also receives data from the specific Response System, including video and audio data to identify the effectiveness of the response. Commands generated by the Operators are forwarded to the NMCCMS where they are authorized, analyzed, coordinated with command and control data generated by the NMCCMS, and then forwarded to the DMAS where the input data is packetized and separated into individual data streams for Camera Command and Control Data, Positioning Command and Control data, Sensor Command and Control Data, Response System Command and Control Data, Monitor and Control data, and Other data. The individual data streams are then forwarded to one or more multiplexors (169) where the data streams are combined, then forwarded to an encryptor (161) which encrypts the data as required by the Conditional Access System (181), and then forwards the encrypted data to the Uplink Modulator (149) which provides an RF signal at the specific RF frequency that the Local Communications Satellite transponder is tuned to. In a large NVMS there may be a number of Modulators and Demodulators each tuned to a specific transponder frequency, thus allowing for greater Satellite Terminal Density in a specific geographic area of coverage, and/or a number of areas of geographic coverage. The Network Management System and Command, Control, and Display Center (173) may also be increased in size, computing power, and number of Displays and Operators, as the number of Satellite Terminals and geographic areas are increased. The output of the Uplink Modulator (149) is forwarded to the Satellite Earth Terminal (145) where the RF signal is amplified by an appropriate power amplifier and then forwarded to the uplink port of the antenna pointing at the Local Communications Satellite. The routing of technical and administrative data may be accomplished via an internal local area network (LAN) with appropriate security safeguards, such as multi-level passwords and firewalls to prevent unauthorized access.

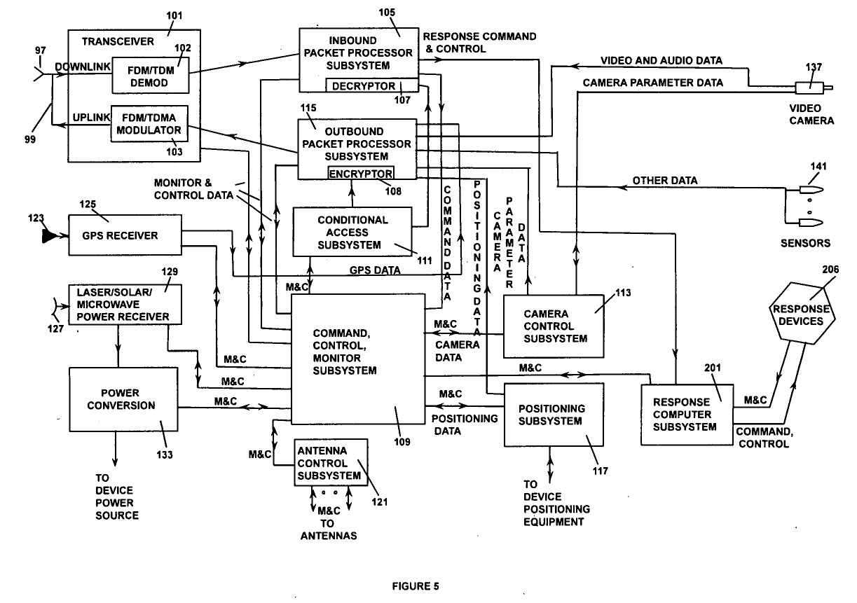

Referring to FIG. 5, the fifth system is the Response System. The mission of the Response System is provide a timely response to commands generated and delivered to such Response System Devices from the Network/Video Management System after analysis of data collected by the various Devices in the geographic area of interest. The Response System Devices may be drones, aircraft, helicopters, land based vehicles, and other types of devices, any of which may be manned or unmanned. Each of these vehicles or devices will have a Satellite Terminal with many or all of the capabilities as described previously during the discussion of FIG. 3. However, it is likely most applications of the Response System will not require the complement of video cameras (137) and/or sensors (141) required in Vehicle-Devices used for data collection, nor will they necessarily need the optional power receiver (129) and power conversion subsystems (133), The Satellite Terminal will have an additional computer, the Response Computer Subsystem (201), which will receive Command and Control Data from the Inbound Packet Processor Subsystem (105) and from the internal Command, Control, and Monitor Subsystem (109). The Response Computer Subsystem (201) will then deliver the Command and Control instructions to the specific Response System Device (206) which is part of the equipment of the Vehicle/Device which the Satellite Terminal resides in. The Response Device (206) will comply with the instructions and report back the actions and the results to the Response Computer Subsystem (201). For example, a drone may have attached to it missiles and bombs or other munitions which could be used for a military response, or if an environmental emergency exists the Response Device (206) could drop food, emergency equipment, medical supplies, and/or issue instructions from a loudspeaker. The Response Devices (206) could also include terrestrial radio communications equipment so that the Response Computer Subsystem (201) can send and receive data from Response Devices (206) which are detached from the Response System, and to send and receive voice and data to/from local entities that need such communications, particularly in an emergency. Thus even Geographic Information Subsystem data could be distributed over a wide area and used for countless applications. The feedback of data from the Response Devices, Sensors and Video Cameras will provide the Network Video Management Systems with real time updates on the status of all the geographic areas of interest, and thus the ability to analyze and issue further instructions to the appropriate Response Systems and Response Devices.

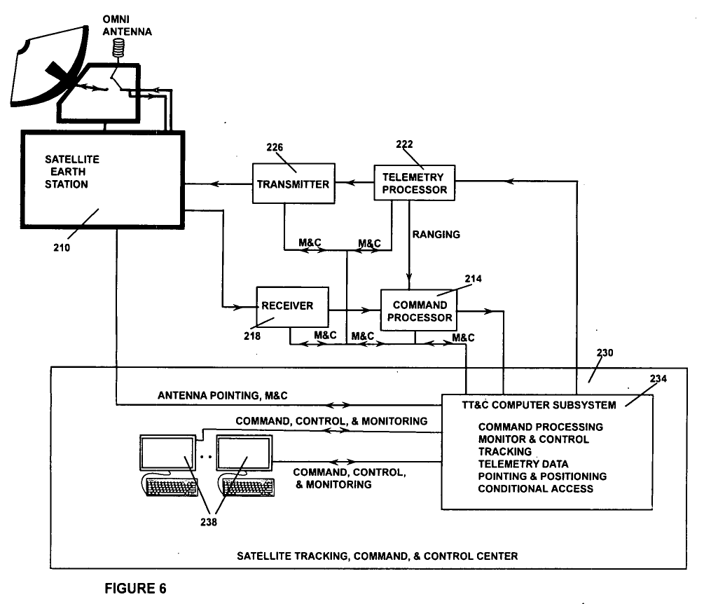

Referring to FIG. 6, the sixth system is the Satellite Telemetry, Tracking, and Control Station (TT&C), which comprises A Satellite Earth Station (210), RF Receivers (218) which forward command data to a Command Processor (214), A Telemetry Processor (222) which forwards telemetry and ranging data to RF Transmitters (226), and a Satellite Tracking, Command, and Control Center (220) which comprises a TT&C Computer Subsystem (234) and System Operator Computer Terminals (238). The conventional mission of the TT&C is to first acquire its associated satellites within its field of view and then issue Commands to properly orient a specific satellite, move the satellite into its allocated location, and once on location and correctly oriented, provide the Command and Control instructions to maintain the satellite in its correct location for the life of the satellite. If a satellite is to be repositioned during its lifetime, the TT&C issues such instructions and monitors the move to assure the satellite does not go astray. The TT&C monitors the performance of all the modules of the satellite, and can reconfigure frequency and transponder assignments and redundancy options. In a preferred version of the present invention, the TT&C provides time synchronization signals to all the satellites of the Satellite Communications System from the Master TT&C Station or a designated backup station. A TT&C Station receives command and control data from an associated NVMS with instructions to reposition its associated Communications Satellite, as authorized, with minimal effect on system performance during transition, and minimal effect on satellite life. The NVMS also provides instructions regarding the transponder frequencies. These instructions and the TT&C response confirmations may be communicated between the TT&C and NVMS via the associated Communications Satellite and/or a point-to-point RF link or landline.

In an alternate version of the present invention a large Vehicle-Device, such as a lighter-than-air aerial vehicle may combine the NVMS, and features and functions of the Satellite Terminal's of Vehicle-Devices and Response Systems, and communicate with the Communications Satellite System and/or by radio frequencies with ground stations. Transmission links between such aerial vehicles could be similar to those described previously in the description of the satellite payload system.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

In the following claims, those claims which do not contain the words “means for” are not intended to be interpreted in accordance with 35 U.S.C. section 112, paragraph 6.

The invention claimed is:

1. A system for collection, delivery, and analysis of video, audio, sensor, and other data from any global geographic areas selected by a specific application, to a plurality of users and devices who may be located at any specified global sites and who may issue commands to a many users and devices, comprising:
a) a communications satellites system, comprising one or more special communications satellite with a specialized satellite payload system;
b) network/video management systems;
c) a satellite telemetry, tracking, and control station associated with each communications satellite;
d) vehicle-device systems associated with each such satellite;
e) response systems associated with each such satellite;
f) communications data packet formats utilized are system-wide packet formats which may be customized to meet application and security requirements.

2. The system of claim 1, wherein the satellite payload system of the communications satellite includes combinations and elements which are conventional or known, wherein the improvements comprises:
a) antennas which provide RF and/or laser transmission to and from other compatible communications satellites;
b) antennas which provide optional radiated power, utilizing RF and/or laser frequencies, to the satellite terminal systems within vehicle-device and response systems;
c) network/video management system receivers which receive RF transmissions from antennas pointed at a network/video management system's earth station antenna, and demodulate the signals to baseband data streams;
d) device receivers which receive RF transmissions from antennas pointed at a group of satellite terminal antennas within vehicle-device and response systems, and demodulate the signals to baseband data streams;
e) a packet processing and routing baseband subsystem which reads the header fields of each packet in each data stream inputted to it, identifies the sources, destinations, priority, and timing of each packet, and other fields which may be necessary for the proper distribution of data packets to recipients, and then formats the packets into data streams based on criteria supplied by an authorized network/video management system command and control center, or when applicable by its associated satellite telemetry, tracking, and control station;
f) a supercomputer capable of handling a multitude of threads of graphics/video data at hyper processing speeds, which receives video/graphics data packets from the packet processing and routing baseband subsystem as commanded by the network/video management system, when on-board processing provides enhanced system throughput by processing the data at a single location, and possibly compressing the data, and then delivering this data to many sites and devices;
g) satellite to satellite communications subsystems for two-way transmission between communications satellites of this communications satellite system.
h) a laser/microwave radiated power distribution subsystem which amplifies and radiates microwave and/or laser power at frequencies which provide higher conversion efficiency when received by semiconductor cell such as solar cells, and which utilizes a number of antennas directed at specific groups of vehicle-devices such as unmanned aerial vehicles (UAV);
i) a power conversion subsystem which receives power from solar panels and converts the power to microwave and/or laser power at frequencies specified by the satellite performance monitoring and control subsystem;
j) A satellite performance monitoring and control subsystem which improves upon the conventional functioning of this subsystem wherein the satellite performance monitoring and control subsystems also may receives commands from an authorized network/video management system to move an associated communications satellite to a new location in coordination with other satellite communications system reconfigurations while maintaining communications links, and minimizing the effect on satellite life;
1) communications between the satellite performance monitoring and control subsystem and a network/video management system may be via the packet processing and routing baseband subsystem of the communications satellite and/or via optional land or radio transmission lines, particularly when the satellite telemetry, tracking, and control station is located near a network/video management system facility.

3. The system of claim 1, wherein the network/video management system of the communications satellite system includes combinations and elements which are conventional or known, wherein the improvements comprises:
a) a satellite earth terminal which receives command, and control data from the network management command, control, & monitoring subsystem of the network/video management system, and sends satellite earth terminal monitor and control data to the network management command, control, & monitoring subsystem;
b) a demultiplexor which receives data streams, reads the packet header fields and then separates the packets into data streams for each defined type of data, such as GPS data, video and audio data, positioning data, sensor data, response system data, camera parameter data, monitor and control data, and other data;
1) each data stream contains data packets from those satellite terminals which are transmitting data packets to their local communications satellite, and data packets which, having destination addresses of the specific network/video management system, have been forwarded from another communications satellite to the communications satellite which is communicating with the specific network/video management system;
c) a network management system and command, control, and display center which is further comprised of:
1) a data management and analysis subsystem, and geographic information subsystem which receive the individual data streams from the demultiplexor, and then processes the data streams to provide the functionality required by the network management system and command, control, and display center;
2) a network management command, control, and monitoring subsystem which sends and receives monitoring and control data to/from all the equipments and subsystems for which it is responsible for, and receives commands from other network/video management systems, if any, and then send command and control data to each device and subsystem which are part of the network, or networks, which this network/video management system is responsible for;
3) a display center which comprises:
a. operator controllable computer terminals which can initiate command and control instructions which result in the display of maps, and/or video, and turning on audio equipment,
b. operator controllable computer terminals which can be used to analyze video data and map data,
c. operator controllable computer terminals which may utilize internal software to command and control displays automatically,
d. electronic displays and/or display walls and associated audio equipment.

4. The system of claim 1, wherein the satellite telemetry, tracking, and control station (TT&C) of the communications satellites system includes combinations and elements which are conventional or known, wherein the improvements comprises:
a) software which, if an authorized command is issued to move a communications satellite which is subject to monitor and control by a specific satellite telemetry, tracking, and control station, then that TT&C shall reposition the communications satellite in a manner which minimizes the possibility of disruption of communications with that satellite's earth terminals, and has minimal effect on satellite life.

5. The system of claim 1, wherein the vehicle-device of the communications satellites system may be a wide variety of types of vehicles and equipments such as unmanned aerial vehicles (UAV), robots, cyborgs, sensors, and land based vehicles, each of which have within them a satellite terminal which includes combinations and elements which are conventional or known, wherein the improvements comprises:
a) an inbound packet processor subsystem which reads the source and destination identification numbers and addresses of each packet to determine if the data packet has a destination address of equipment or subsystems within that vehicle-device system;
b) a command, control, and monitor subsystem which receive a data stream of command data from the inbound packet processor, and monitor and control data streams from and to all the equipments and subsystems of the specific vehicle-device and the satellite terminal within;
1) a database of all equipments, and subsystems, and their status, operational condition, and other pertinent data is stored within this subsystem;
c) a GPS antenna and receiver which provides accurate three position data of the location of a satellite terminal;
d) a positioning subsystem which receives positioning commands from the command, control, and monitoring subsystem, and
1) issues commands to the particular vehicle-device positioning equipment, and
2) monitors the GPS data and issues corrective commands to maintain the desired position and orientation;
e) a camera control subsystem provides camera parameter command and control data to each video camera included in a satellite terminal within a specific vehicle-device, wherein;
1) command and control data may include data for the video camera and for audio, if any,
2) monitor and control data is also received from the video camera so that the actual performance of the video and audio are known to the camera control subsystem and corrective action can be taken if necessary;
f) one or more sensors, depending on the application and the vehicle-device size and capabilities;
g) an outbound packet processor subsystem which receives video and audio data streams from each video camera, sensor or other data from each sensor or other device, camera parameter and positioning data, GPS data, monitor and control data, and conditional access data which is then delivered to an encryptor, and then encrypted, packetized, and multiplexed into an output data stream;
h) an antenna control subsystem whose function is to control the position of each antenna of the satellite terminal to acquire the correct communications satellite and then to continue to point at that satellite to maintain communications;
i) a laser/solar/microwave power receiver which may comprise an antenna and/or a semiconductor cell array which receives energy from a laser and/or microwave beam transmitted by an associated communications satellite, and/or solar energy impinging on the surface of the device, and a monitor and control interface to the command, control, and monitor subsystem of the vehicle device to track the performance of this power receiver;
j) a power conversion subsystem converts the energy received from the power receiver to the appropriate format required as an input to the device power source, and has an interface to the command, control, and monitor subsystem of the vehicle-device, and provides the data necessary to compute the effect of the power receiver on the operational life of the device.

6. The system of claim 1, wherein the response system of the communications satellites system may be a wide variety of types of vehicles and devices such as unmanned aerial vehicles (UAV), manned aerial vehicles, and land based vehicles, each of which have within them a satellite terminal which includes combinations and elements which are conventional or known, wherein the improvements comprises:
a) an inbound packet processor subsystem which reads the source and destination identification numbers and addresses of each packet to determine if the data packet has a destination address of equipment, or subsystems within that response system;
b) a command, control, and monitor subsystem which receive a data stream of command data from the inbound packet processor, and monitor and control data streams from and to all the equipments, and subsystems of the specific response system device and the satellite terminal within;
1) a database of all equipments, and subsystems, and their status, operational condition, and other pertinent data is stored within this subsystem;
c) a GPS antenna and receiver which provides accurate three position data of the location of the satellite terminal of a response system;
d) a positioning subsystem receives positioning commands from the command, control, and monitoring subsystem, and
1) issues commands to the particular response system device positioning equipment, and
2) monitors the GPS data and issues corrective commands to maintain the desired position and orientation;
e) a camera control subsystem provides camera parameter command and control data to each video camera included in a satellite terminal within a specific response system, wherein;
1) command and control data may include data for the video camera and for audio, if any,
2) monitor and control data is also received from the video camera so that the actual performance of the video and audio are known to the camera control subsystem and corrective action can be taken if necessary;
f) optional sensors, depending on the application and the response system device size and capabilities;
g) an outbound packet processor subsystem which receives video and audio data streams from each video camera, sensor or other data from each sensor or other equipment, camera parameter and positioning data, GPS data, monitor and control data, response system data, and conditional access data which is then delivered to an encryptor, and then encrypted, packetized, and multiplexed into an output data stream;
h) an antenna control subsystem whose function is to control the position of each antenna of the satellite terminal to acquire the correct communications satellite and then to continue to point at that satellite to maintain communications;
i) a response computer subsystem which receives response command and control data from the inbound packet processor subsystem, processes the data and forwards command and control data to each response device as specified by the commands; and
1) monitor and control data from the response devices are reviewed to determine if further commands are necessary, and to ascertain the results of the responses of the response devices;
2) monitor and control data is then forwarded to the command, control, monitor subsystem;
3) an optional RF transceiver may be included in the response computer subsystem to maintain links with response devices which are physically detached from the response system;
l) response devices which, depending on the application, may vary in quantity, size, capabilities, and mission;
1) each response device receives authorized command and control data from the response computer subsystem, and sends data to the response computer subsystem regarding its operational status and response to commands;
2) an optional RF transceiver may be included in the response device to maintain links with the response computer subsystem if physically detached from the response system device;
m) an optional laser/solar/microwave power receiver which may include an antenna and/or a semiconductor cell array which receives energy from a laser and/or microwave beam transmitted by the associated communications satellite, and/or solar energy impinging on the response system device, and a monitor and control interface to the command, control, and monitor subsystem of the specific response system to track the performance of this power receiver;
n) an optional power conversion subsystem which converts the energy received from the power receiver to the appropriate format required as an input to the response system device power source, and an interface to the command, control, monitor subsystem provides the data necessary to compute the effect of the power receiver on the operational life of the response system device.

7. The method of claim 2, wherein a communications satellite has a payload system with two-way RF transmission links with one or more associated network/video management systems.

8. The method of claim 2, wherein a communications satellite has a payload system with two-way RF transmission links with one or more associated satellite terminals of vehicle-devices and/or response systems.

9. The method of claim 2, wherein a satellite performance monitoring and control subsystem monitors and controls all the equipment, and subsystems of the satellite payload system and also the other systems and subsystems of the communications satellite, sand issues commands received from a network/video management system.

10. The method of claim 2, wherein RF or Laser communications transmissions, received from the payload system of another communications satellite of the system, by an auto-tracking antenna, and are, either passed through the payload system of the particular communications satellite of the system to another satellite payload system of a communications satellite of the system, utilizing an RF/optical internal transmission system, without further processing, and/or the signal is passed into the payload system of the particular communications satellite for packet processing and routing which may result in rerouting of data packets to ports with other destinations, or addition of data packets with destination addresses at another communications satellite of the system, and then routing this revised data stream to an appropriate RF/Laser modulator/multiplexer, and then to the output auto-tracking antenna used to communicate with the next communications satellite

11. The method of claim 2, wherein RF and or laser communications signals are received by antennas and forwarded to an input satellite to satellite communications subsystem which comprises;
a) a two way splitter;
b) a two way combiner of an output satellite to satellite communications subsystem, which receives a signal from one of the ports of the splitter utilizing RF cables or fiberoptic cables so that, while frequency conversion may be utilized within the satellite to satellite communications subsystems to prevent input/output interference, no demodulation to baseband is required;
c) the input satellite to satellite communications subsystem includes demodulators, which receives a signal from a second port of the splitters within the input satellite to satellite communications subsystem, then demodulates the signal to baseband data packet streams and reads the destination fields to determine if a data packet destination is within the specific communications satellite or any of the satellite terminals and/or network/video management systems which are communicating with this communications satellite, and those data packets which have such destinations are forwarded to an any input to any output switch.

12. The method of claim 2, wherein a baseband any input to any output switch directs data streams to assigned input ports of the packet processing and routing baseband subsystem which uses the ID, source, and destination information to direct each packet, with appropriate timing, to an assigned output port of the processor, and
a) each port is connected to an input port of a second any input to any output switch, and
b) the output ports of this switch are connected to either network/video management system transmitter, or devices distribution transmitters.

13. The method of claim 2, wherein data packets with destination addresses which are within another communications satellite are forwarded from the packet processing and routing baseband subsystem to an any input to any output switch, and then to the appropriate input port of the output satellite to satellite communications subsystem, wherein the packets are reformatted into the format required by the laser and/or microwave modulators and then forwarded to the appropriate antennas.

14. The method of claim 2, wherein input/output ports are connected from the packet processing and routing baseband subsystem to a graphics processing supercomputer which provides the capability to analyze and process multiple data streams simultaneously of video and graphic data, as directed by command data packets received from a network/video management system, wherein the analysis may result in special video compression methods, feature recognition and enhancement, digital zoom, person or feature identification, and other technologies which enhance the data and/or reduce the transmission of redundant data, particularly where such data is used by multiple network/video management systems.

15. The method of claim 3, wherein a demultiplexor receives data streams, and
a) reads each packet header field in each data stream, and filters out data packets with destination addresses not within the network/video management system, and
b) separates the packets into individual data streams for each defined type of data such as GPS data, video and audio data, sensor data, response system data, positioning data, camera parameter data, monitor and control data, and other data.

16. The method of claim 3, wherein the data management and analysis subsystem of the network management system and command, control, and display center receives data streams from the demultiplexor, and
a) reads the header fields to separate the data packets based on the identification number of the device, the time stamp, the type of data, the data compression ratio, and any other parameter which is necessary to recreate data streams of the original data, and then
b) performs analysis to correlate video and audio data with the camera identification number, and that camera's parameter data such as view angle, zoom setting, area of coverage, light sensitivity setting, aspect ratio, frame rate, etc., the device GPS and positioning data, any other device data which defines the parameters of the video and audio data, and then
c) stores the resultant data files in mass storage at any specified stage of the processing as encrypted or unencrypted data files and with and without data compression, and with the ability to restore files to their previous state prior to storage, and
d) the processed files are then forwarded to the geographic information subsystem for processing by geographic information software, or forwarded to the command control, and display center for viewing and/or operator analysis, and
e) receives data packets from the network management command, control, and monitoring subsystem that have destinations that include communications satellites, network/video management systems, vehicle-devices, response systems, and TT&C stations, and forwards them to a multiplexor.

17. The method of claim 3, wherein data files received by the geographic information subsystem are analyzes by geographic information system software which produces data files which, when used in conjunction with the geographic information system software, produces accurate, scalable area maps which can show the satellite terminal locations as points on the map, and
a) can also show video frame data as a raster overlay on such a map, in which from one to all of the video frames, with the same timestamp, of the video cameras within a specific vehicle-device, response system, and response device can be presented on a area map in real time or delayed by storing all the video, audio, and other files in mass storage media of this subsystem, and
b) can analyze sensor data files, together with GPS data files, and produce data files, which when used in conjunction with geographic information system software can produce area maps which accurately show the position of each such sensor, with or without raster video layers, on area maps, and
c) can produce interpretive or predictive maps based on analysis of the data such as environmental data from sensors and successive video frame data.

18. The method of claim 3, wherein a network management command, control, and monitoring subsystem includes functions which are conventional or known, wherein the improvements comprises:
a) maintaining an up-to-date database of all systems, subsystems, devices, and equipments which it communicates with, including identification numbers, characteristics, specifications, status, operational and failure history, and other data necessary to perform its command, control, and monitoring duties;
b) receiving commands from the display center computer terminals, including operator initiated command and control instructions;
c) packetizing command and control data received from the display center that has destinations that include communications satellites and/or other network/video management systems with source, destination, time stamp, and other data;
d) forwarding that packetized data to the data management and analysis subsystem.

19. The system of claim 3, wherein the computer terminals of the display center include a storage playback system which comprise a storage media which receives Geographic Information Subsystem data, video, and audio data streams from the data management and analysis subsystem, and geographic information subsystem and stores the video, audio, and data files for playback by system operators.

20. The method of claim 3, wherein command, control, and monitoring data provided by the display center is forwarded to the network management command, control, and monitoring subsystem which reads the destination identifications, and then forwards command and control data with destinations internal to the network/video management system to the destination subsystem, and forwards command and control data with external destinations to the data management and analysis subsystem, which then formats the data into packets with source and destination identifications, data types, time stamps, and other fields as specified by a system-wide packet format specification, and then the packets are separated by type into data streams which are then forwarded to one or more multiplexors, depending on applications and devices quantities and geographic area of coverage and devices density.

21. The method of claim 3, wherein the multiplexor combines the individual data streams, such as camera command and control data, positioning command and control data, sensor command and control data, response command and control data, monitor and control data, and other data, into a single data stream with time stamp in appropriate order.

22. The method of claim 4, wherein the satellite telemetry, tracking, and control station (TT&C) receives command, and control data from a network/video management system that commands a repositioning of an associated communications satellite, and the TT&C issues commands to that communications satellite, monitors the satellite's movement to the new position, and sends this monitoring data to the network/video systems which require this data. The TT&C provides command, control, and monitoring concerning the performance of solar power conversion, and laser/microwave radiated power distribution subsystems.

23. The method of claim 4, wherein the TT&C provides
a) command, control, and monitoring concerning the performance of solar power conversion, and laser/microwave radiated power distribution subsystems;
b) turn on or off these subsystems;
c) modify their power conversion and radiated power parameters, based on communications satellite performance criteria and/or command and control data issued by an authorized network/video management system.

24. The method of claim 5, wherein an inbound packet processor subsystem of a satellite terminal within a vehicle-device, or response system, reads the source and destination identification numbers and addresses of each packet to determine if the data packet has a destination address of equipment, or subsystems within that vehicle-device, or response system, and/or its satellite terminal, and
a) accepted data packets are decrypted, and
b) reordered into individual data streams according to type and time, and
c) forwarded to an appropriate subsystem for further processing.

25. The method of claim 5, wherein the positioning subsystem
a) receives positioning command and control data packets from the command, control, and monitoring subsystem;
b) reads and analyzes the packets, and if appropriate reformats the data into the format required by the device positioning equipment;
c) receives GPS location error control data from command, control, and monitoring subsystem, and then
d) issues commands to the device positioning equipment to maintain accuracy of location.

26. The method of claim 5, wherein the camera control subsystem
a) receives camera command and control data packets from the command, control, and monitoring subsystem, and
b) reads and analyzes the packets, and if appropriate reformats the data into the format required by the camera internal control system, and
c) issues commands to video cameras.

27. The method of claim 5, wherein the outbound packet processor subsystem
a) receives video and audio data streams from each of the video cameras, sensor and other data from each sensor;
b) receives packetized camera parameter data streams from the camera control subsystem;
c) receives packetized positioning data streams from the positioning subsystem;
d) receives GPS data from the GPS receiver,
e) receives monitoring, command, and control data from the command, control, and monitoring subsystem;
f) receives conditional access and encryption instructions from the conditional access subsystem, and then
g) formats the individual data streams a single data stream of packets with source and destination identifications, data types, time stamps, and other fields as specified by a system-wide packet format specification, and then
h) forwards the resultant data stream to the input of an RF modulator.

28. The method of claim 6, wherein a response system may have within it essentially all the subsystems, equipments, and functionality of a vehicle-device, and in addition, have a variety of response devices, which may be detached from a response system upon command from an authorized network/video management system which sends command and control data to that specific response computer subsystem.

29. The method of claim 6, wherein the inbound packet processor reads and analyzes data packets with destination addresses within the specific response system, and
a) forwards response command and control data to the response computer subsystem, which;
1) reads and analyzes the data packets to determine which response devices are to receive commands, if more than one is present;
2) determines what commands are to be given and to which subsystems and equipment of the response device, such as location and timing parameters under the control of the response devices, and other commands required by the response devices to carry out their mission successfully;
3) issues commands to video cameras and/or sensors, if present;
4) sends acknowledgements and other feedback data back to the source destinations.

30. The system of claim 1, wherein the network/video management systems may comprise a master network/video management system, a number of regional network/video management systems, and a number of local network/video management video management systems.

31. The method of claim 30, wherein the master network/video management system has primary responsibility for
a) all security policies and technologies;
b) command and control of any and all sources of data and responses;
c) establishment of destination addresses for all sources of data;
d) viewing any or all the video, audio, sensor, response data, and maps produced from source data in its display center;
e) delegating any of its responsibilities to other network/video management systems.

32. The method of claim 30, wherein the regional network/video management system has primary responsibility in those geographic areas for which this responsibility has been delegated to it by the master network/video management system, and may delegate any of its responsibilities to other network\video management systems within its geographic area of responsibility.

33. The method of claim 30, wherein the local network/video management system has primary responsibility in those geographic areas for which this responsibility has been delegated to it by the master or regional network/video management system.

34. A method for creating geographic maps with rasterized sequential video frames utilizing computer processing, wherein
a) a source video file is converted into time stamped video frames and then,
b) converted into individual sets of raster data and associated geodatabase files, utilizing geographic information system software, and then;
c) can be displayed frame by frame, in real-time, as layers on a geographic map, with accuracy, scalability, and the ability to add layers of details stored in the geodatabase on request by an operator;
d) can be analyzed further by the geographic information system software based on operator defined criteria, operator observation.
